(19) United States
(12) Patent Application Publication
(10) Pub. No.: US 2025/0364202 A1
(43) Pub. Date: Nov. 27, 2025

(54) KLYSTRON

(71) Applicant: CANON ELECTRON TUBES & DEVICES CO., LTD., Otawara-shi (JP)

(72) Inventor: Naoya MUNEMOTO, Nasushiobara (JP)

(73) Assignee: CANON ELECTRON TUBES & DEVICES CO., LTD., Otawara-shi (JP)

(21) Appl. No.: 19/244,570

(22) Filed: Jun. 20, 2025

Related U.S. Application Data
(63) Continuation of application No. PCT/JP2023/045636, filed on Dec. 20, 2023.

(30) Foreign Application Priority Data
Dec. 22, 2022 (JP) 2022-205628

(51) Int. Cl. H01J 25/10; H01J 23/087

(52) U.S. Cl. CPC H01J 25/10; H01J 23/087

(57) ABSTRACT

According to one embodiment, a klystron includes a high-frequency interaction unit, a main magnet arranged in a ring shape around the high-frequency interaction unit, an output waveguide, an auxiliary magnet arranged in a ring shape opposing the output waveguide, an output unit for extracting high-frequency power from the output waveguide, and an output adjustment mechanism which adjusts the output of the high-frequency power extracted from the output unit by deforming the output waveguide. In the output adjustment mechanism, the output waveguide is deformed by engaging a distal end of a jig inserted from an outside of the auxiliary magnet via a jig insertion hole with an engagement member and pushing or pulling the engagement member.

### CROSS-REFERENCE TO RELATED APPLICATIONS

This application is a Continuation Application of PCT Application No. PCT/JP2023/045636, filed Dec. 20, 2023 and based upon and claiming the benefit of priority from Japanese Patent Application No. 2022-205628, filed Dec. 22, 2022, the entire contents of all of which are incorporated herein by reference.

### FIELD

Embodiments described herein relate generally to a klystron.

### BACKGROUND

Klystrons are microwave tubes used for amplifying high-frequency power, and comprise a high-frequency interaction unit that amplifies the high-frequency power input by the interaction of the high-frequency electric field with the electron beam output from an electron gun, a main magnet provided in a ring shape around the high-frequency interaction unit, an output waveguide connected to the high-frequency interaction unit, an auxiliary magnet provided in a ring shape at a position corresponding to the output waveguide, and an output unit connected to the output waveguide.

Generally, klystrons have one or two ports as an output unit for outputting high-frequency (RF) power. In the extraction of high-frequency power, strong electric field intensity is accompanied by the following risks.

The first risk is breakdown of ceramic, creation of pinhole, and generation of cracks due to thermal deformation in the window ceramic of the high-frequency output window (high-frequency output unit).

The second risk is increase in the rate of electrical discharge in the operating environment of the high-frequency output window (high-frequency output unit).

In order to avoid these risks which may arise, it is necessary to reduce the electric field strength. Further, in the case where long pulse width and high repetition operation conditions are required in high-frequency output units, two-port outputs are selected in many cases.

In the case of two-port output, there are such usage that the high-frequency power output from each port (high-frequency output unit) may be supplied to a respective separate system, depending on the customer's application, and the output balance need to be matched.

The adjustment of output balance for each port is mainly performed by the followings: the shape of the output waveguide provided between the high-frequency interaction unit and the high-frequency output unit is changed, and the impedance of the output waveguide is changed, and thus that the high-frequency (RF) power output from each high-frequency output unit is adjusted to be within the customer's required specifications.

In order to adjust the output balance, the auxiliary magnet is removed from the klystron, the klystron structure is separated from the test equipment such as the dummy load, and then adjustment and retesting are carried out. Here, in the klystron structure, the impedance of each port is changed by deforming the shape of the waveguide of the output unit, and thus the output balance of each port is adjusted.

As discussed above, because it is necessary to remove the auxiliary magnet and separate the klystron structure, and the like, there involves a drawback that the lead time for implementing adjustments becomes long.

In particular, it is necessary to repeatedly remove the klystron structure only, for adjustment and resetting, and then conduct tests, and therefore the lead time becomes enormous.

One of the objects of the present embodiment is to provide a klystron that can adjust the output in a short time.

### BRIEF DESCRIPTION OF THE DRAWINGS

FIG. 1 is a perspective view schematically showing a brief structure of a klystron according to an embodiment, and section (a) is a diagram showing the klystron structure, and section (b) is a diagram showing the klystron in which a main magnet and an auxiliary magnet are attached to the klystron structure.

FIG. 2 is a cross-sectional view of the klystron of the embodiment, and section (a) is a diagram showing the klystron in its entirety, section (b) is an enlarged view of part B shown in (a), and (c) is an enlarged drawing of part C shown in (a).

FIG. 3 is a cross-sectional view showing the state in which the output waveguide is pulled and deformed using a pulling jig.

FIG. 4 is a cross-sectional view showing the state in which the output waveguide is pushed and deformed using a pushing jig.

FIG. 5 is a cross-sectional view briefly showing a deformation of the waveguide.

FIG. 6 is a graph showing the relationship between the output of each output unit (output port) and the amount of deformation of the output waveguide.

FIG. 7 is a diagram illustrating an installation process of the output adjustment mechanism, which is a perspective view showing the klystron structure before the output adjustment mechanism is installed.

FIG. 8 is a diagram illustrating an installation process of the output adjustment mechanism, section (a) is a plan view showing is a diagram illustrating an installation process of the output adjustment mechanism, which is a perspective view the klystron structure in which leg members and engagement members are attached to the output waveguide, and section (b) is a perspective view of the leg members.

FIG. 9 is a diagram illustrating an installation process of the output adjustment mechanism, and section (a) is a plan view showing is a diagram illustrating an installation process of the output adjustment mechanism, which is a perspective view the klystron structure in which a plane member is attached between the leg members, and section (b) is a perspective view of the plane member.

FIG. 10 is a perspective view showing the auxiliary magnet used in the embodiment.

FIG. 11 is a diagram illustrating a method of manufacturing a coil body in the auxiliary magnet shown in FIG. 10, and section (a) is a cross-sectional view showing the coil body during manufacturing, and section (b) is a cross-sectional view showing the auxiliary magnet.

FIG. 12, section (a) is a front view of the pulling jig, and section (b) is a front view of the pushing jig.

### DETAILED DESCRIPTION

In general, according to one embodiment, a klystron comprises an electron gun, a high-frequency interaction unit which amplifies high-frequency power input by interaction between an electron beam output from the electron gun and a high-frequency electric field, a main magnet arranged in a ring-like shape around the high-frequency interaction unit, an output waveguide connected to the high-frequency interaction unit, an auxiliary magnet arranged in a ring-like shape at a position opposing the output waveguide, an output unit which extracts the high-frequency power from the output waveguide, and an output adjustment mechanism which adjusts output of the high-frequency power taken from the output unit by deforming the output waveguide, and the output adjustment mechanism comprises an engagement member fixed to the output waveguide, a jig insertion hole that penetrates from an outer side of the auxiliary magnet towards the engagement member, and a jig which is inserted from the outer side of the auxiliary magnet into the jig insertion hole and engages with the engagement member, and the output waveguide is deformed by pushing or pulling the engagement member while engaging a distal end of the jig inserted from the outer side of the auxiliary magnet through the jig insertion hole with the engagement member.

An embodiment will be described hereinafter with reference to the accompanying drawings. Note that, in some cases, in order to make the description clearer, the widths, thicknesses, shapes, etc., of the respective parts are schematically illustrated in the drawings, compared to the actual modes. However, the schematic illustration is merely an example, and adds no restrictions to the interpretation of the invention. Besides, in the specification and drawings, the same or similar elements as or to those described in connection with preceding drawings or those exhibiting similar functions are denoted by like reference numerals, and a detailed description thereof is omitted unless otherwise necessary.

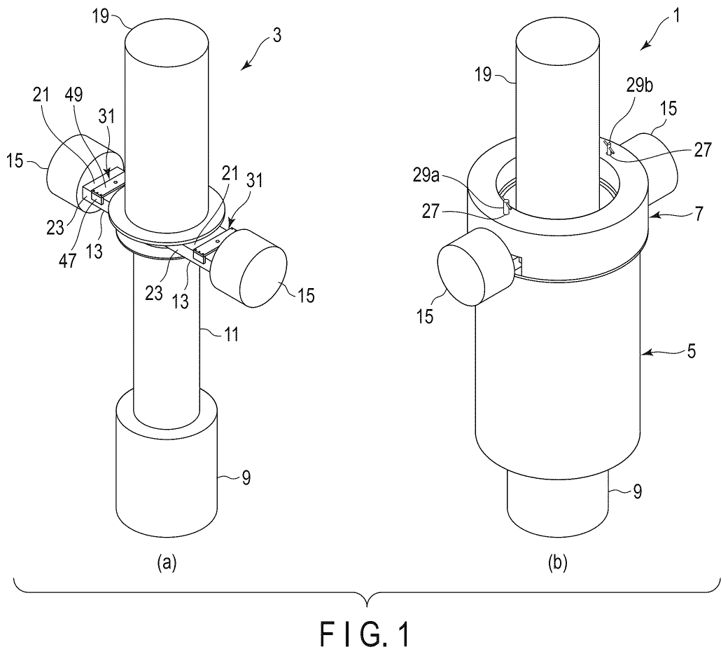

First, with reference to FIGS. 1 to 4, a configuration of a klystron of the embodiment will be explained.

As shown in FIG. 1, section (b), a klystron 1 of the present embodiment is configured by attaching a main magnet 5 and an auxiliary magnet 7 to a klystron structure 3 shown in FIG. 1, section (a).

As shown in FIG. 1, section (a), the klystron structure 3 comprises an electron gun 9, a high-frequency interaction unit 11, an output waveguide 13, an output unit 15, and a collector 19.

The electron gun 9 outputs an electron beam to the high-frequency interaction unit 11.

The high-frequency interaction unit 11 amplifies the input high-frequency power by interacting the electron beam output from the electron gun 9 with a high-frequency electric field.

The output waveguide 13 has one end connected to the high-frequency interaction unit 11 and the other end connected to the output unit 15. The klystron structure 3 of this embodiment is a two-port type klystron structure 3 configured such that two output waveguides 13 are connected while opposing the high-frequency interaction unit 11, and an output unit 15 is provided on each of the output waveguides 13.

The output waveguide 13 has a flat rectangular prismatic shape in this embodiment, and as shown in FIG. 1, section (a), comprises a pair of long side surfaces 21 opposing each other and a pair of short side surfaces 23 opposing each other.

The collector 19 adds the used electrons.

As shown in FIG. 1, section (b), the main magnet 5 is provided in a ring shape around the high-frequency interaction unit 11, and it surrounds the high-frequency interaction unit 11 to give a strong magnetic field to the high-frequency interaction unit 11.

The auxiliary magnet 7 is provided in a ring shape so as to overlap the main magnet 5 at a position opposing the output waveguide 13, and give a strong magnetic field to the output waveguide 13.

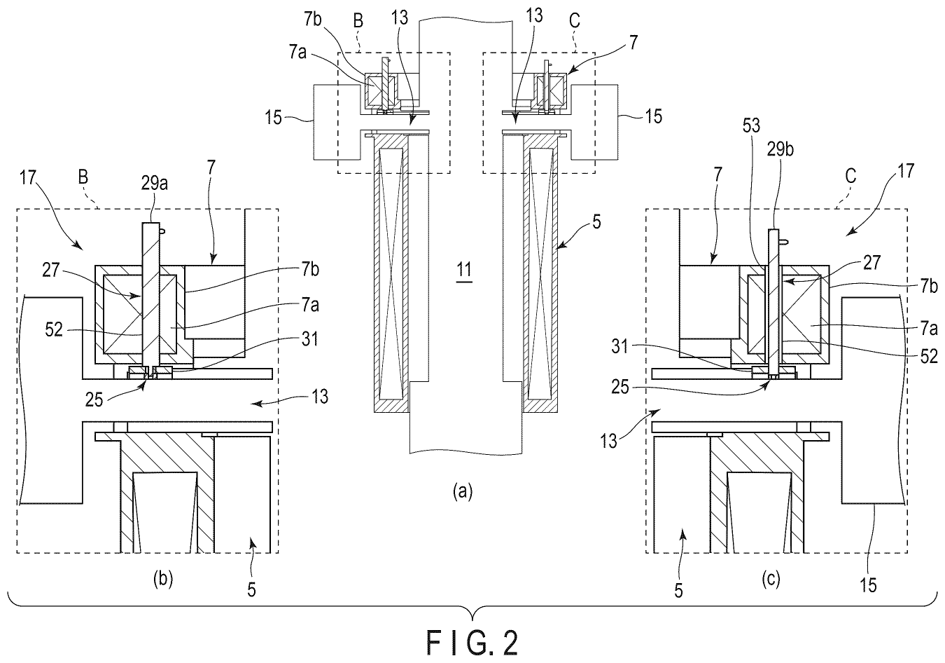

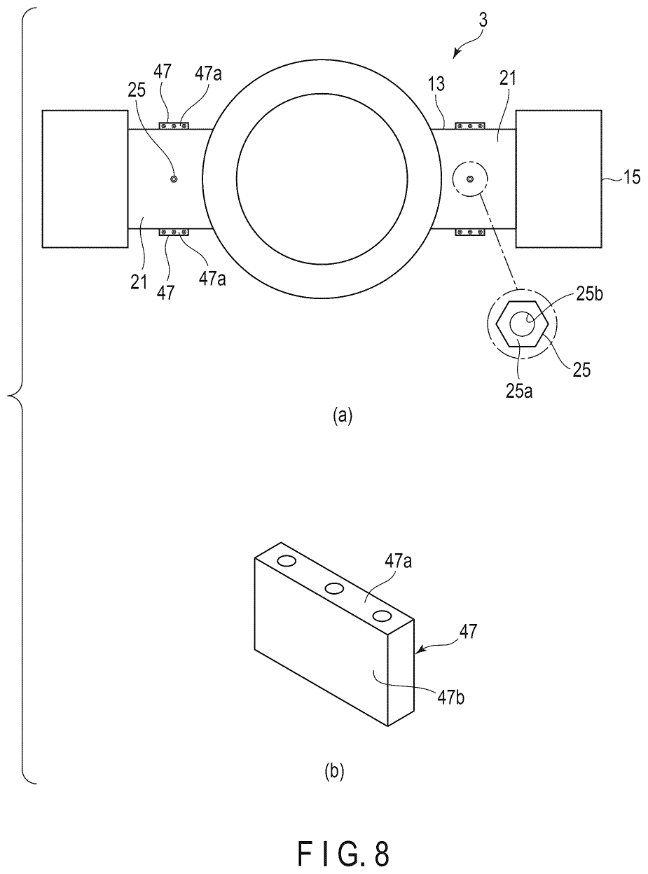

As shown in FIG. 2, the output adjustment mechanism 17 comprises an engagement member 25 (see FIG. 8) fixed to one surface of the output waveguide 13, a jig insertion hole 27 provided in the auxiliary magnet 7, jigs 29a and 29b, and a base 31 (see FIG. 1, section (a)).

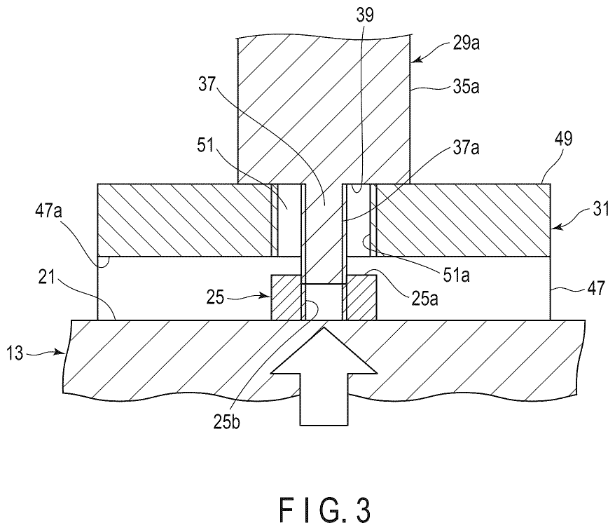

As shown in FIGS. 3 and 8, the engagement member 25 is a ring-shaped member having a flat top surface 25a and a female screw 25b is formed on an inner surface thereof. In this embodiment, a hexagonal nut is used.

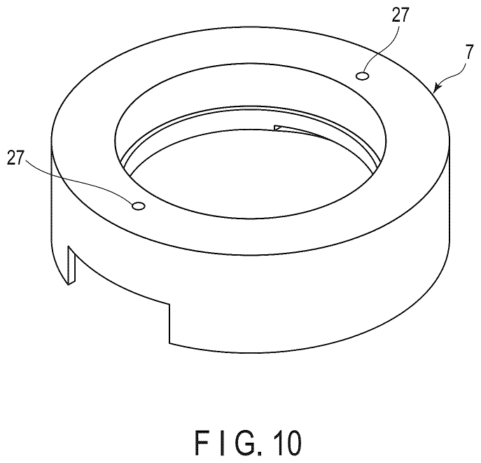

As shown in FIGS. 2 and 10, the jig insertion hole 27 is provided in the auxiliary magnet 7 to oppose the output waveguide 13, and is a hole that penetrates the auxiliary magnet 7 at a position opposing the engagement member 25. The jig insertion hole 27 is formed linearly from an outer side of the auxiliary magnet 7 towards the engagement member 25, and has such a hole diameter with which the pulling jig 29a and pushing jig 29b can be inserted.

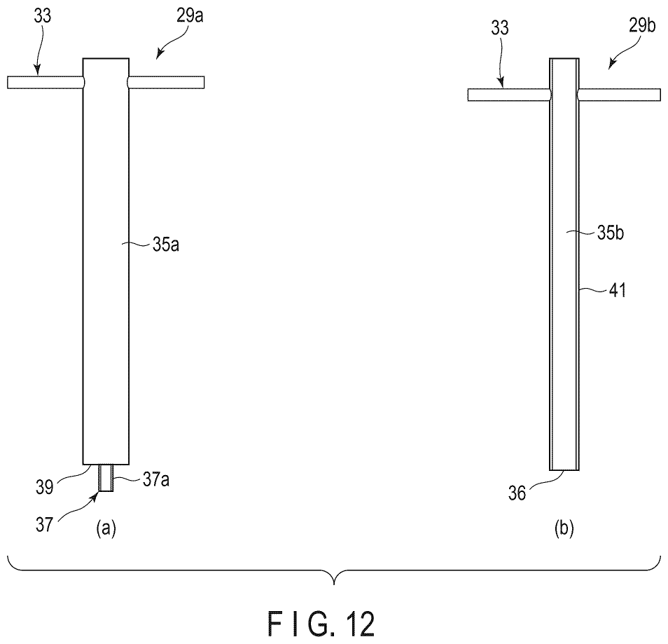

As shown in FIG. 12, section (a), the pulling jig 29a include a main body portion 35a having a rear end provided with a handle 33, and a distal end of the main body 35a forms a distal end portion 37 on which a male screw 37a is formed to be integrated therewith. The diameter of the main body portion 35a is made larger than the diameter of the distal end portion 37, and an end face 39 of the main body portion 35a on a distal end portion 37 side is formed into a ring-shaped surface. As shown in FIG. 3, the male screw 37a of the pulling jig 29a is a screw that screws into the female screw 25b of the engagement member 25.

The pushing jig 29b has, as shown in FIG. 12, section (b), a main body portion 35b having a rear end provided with a handle 33 as in the case of the pulling jig 29a. The main body portion 35b is provided with a male screw 41 formed on the entire circumferential surface thereof. The distal end surface 36 of the main body portion 35b is formed into a flat surface.

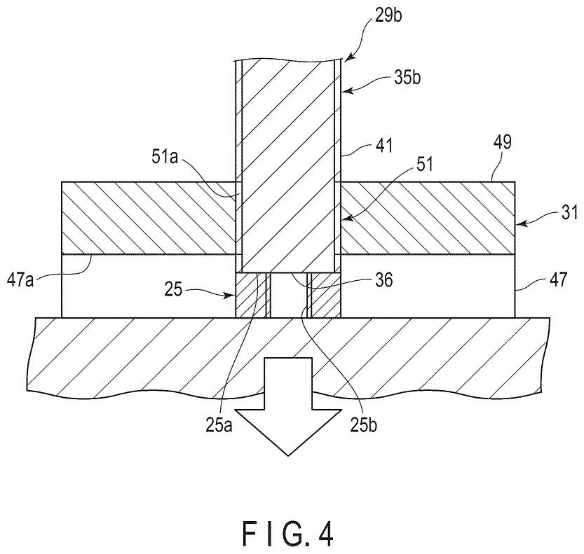

As shown in FIG. 4, the dimension of the diameter of the main body portion 35b is approximately the same as the dimension of the diameter of the engagement member 25, and the distal end surface 36 is brought into contact with the top surface 25a of the engagement member 25 from above.

The male screw 41 is a screw that can be engaged with into the female screw 51a of the base 31, which will be described later.

Next, the base 31 will be explained. As shown in FIGS. 1, section (a), 3 and 4, the base 31 comprises a face member 49 that is provided with a space between the leg members 47 respectively fixed to the pair of opposing short side surfaces 23 (see FIG. 1, section (a)) of the output waveguide 13, and the long side surface 21, to which the engagement member 25 is fixed.

As shown in FIG. 8 and FIG. 1, section (a), the leg members 47 are fixed to the short side surface 23 in the state that the upper ends 47a protrude from the long side surfaces 21 of the output waveguide 13. The leg members 47 are fixed to the short side surfaces 23 of the output waveguide 13 by welding or brazing. A screw hole for screwing a bolt is formed in the upper end 47a of each leg member 47.

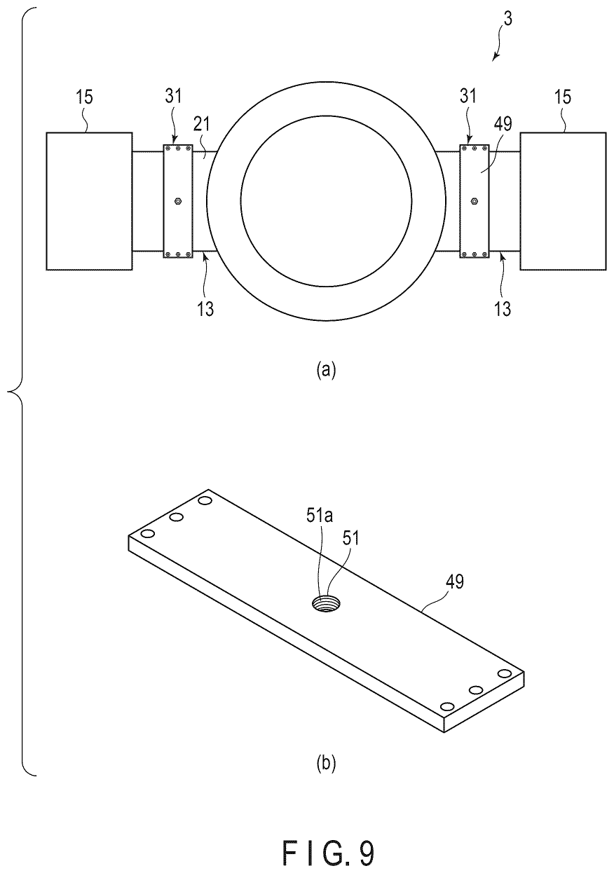

As shown in FIG. 9 and FIG. 1, section (a), the face member 49 is placed on top of the upper end 47a of each of the leg members 47 and 47 opposing each other and is fixed to each of the leg members 47 and 47 with a bolt. As shown in FIGS. 3 and 4, the face member 49 is provided at a distance with respect to the long side surface 21 of the output waveguide 13 and is also provided at a distance between the engagement member 25 and itself.

This face member 49 has a screw hole (female thread portion) 51 formed therein with a female screw 51a at a position opposing the engagement member 25. As shown in FIG. 4, the female screw 51a is thread-engaged with the male screw 41 of the pushing jig 29b.

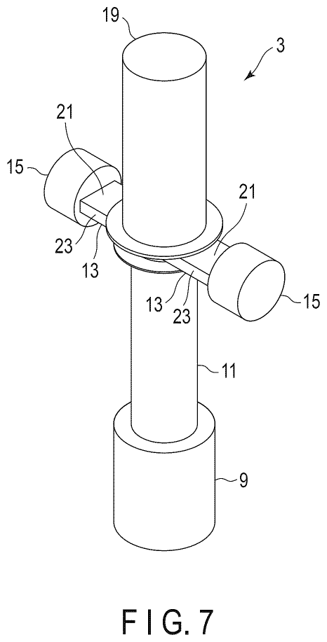

Next, with reference to FIGS. 7 to 11, the procedure of installation of the output adjustment mechanism 17 will be explained.

First, as shown in FIG. 7, the klystron structure 3 is prepared.

Next, as shown in FIG. 8, in the output waveguide 13 of the klystron structure 3, the engagement member 25 is fixed to approximately the center of the upper long side surface 21 thereof. The engagement member 25 is fixed by welding or brazing.

Meanwhile, as shown in FIG. 8 and FIG. 1, section (a), the leg members 47 are fixed to the pair of opposing short side surfaces 23 of the output waveguide 13. The leg members 47 are each disposed such that the upper end 47a protrudes upwards from the respective long side surface 21 (see FIGS. 3 and 4), and the upper end 47a is disposed to be located above the top surface 25a of the engagement member 25, and one side surface 47b is fixed to the short side surface 23 of the output waveguide 13 by welding or brazing.

Next, as shown in FIG. 9, the face member 49 is placed on the upper ends 47a and 47a of the leg members 47 and 47 opposing each other and fixed in place with bolts.

A screw hole 51 is formed in the face member 49, with a female screw 51a formed in advance at approximately the center of the face member 49, in a position opposing the engagement member 25.

Thus, as shown in FIGS. 3 and 4, the base 31, on which the face member 49 is installed with a predetermined distance from the top surface 25a of the engagement member 25, is assembled to the output waveguide 13.

In the meantime, as shown in FIGS. 2 and 10, the jig insertion hole 27 is formed in the auxiliary magnet 7. As can be seen in FIG. 2, section (c), the auxiliary magnet 7 is constituted by a coil body 7a and a case 7b that covers the coil body 7a, and a hole 53 is drilled in the case 7b using a drill or the like. On the other hand, a coil transverse hole 52 is formed in the coil body 7a. Thus, the jig insertion hole 27 is constituted by the hole 53 in the case 7b and the coil transverse hole 52.

Here, the formation of the coil transverse hole 52 will be explained.

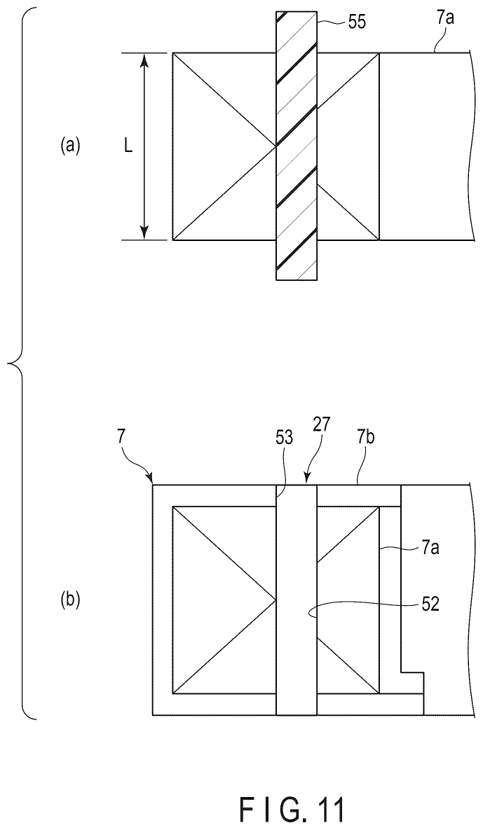

As shown in FIG. 11, section (a), a hole formation member 55 having a diameter the same as the diameter of the jig insertion hole 27 is prepared in advance. The hole formation member 55 is a resin-made cylinder having a dimension longer than the thickness L of the coil body 7a.

Then, with this hole formation member 55 in place, the coil is wound into a ring to form the coil body 7a, and the hole formation member 55 is then removed by pulling it out or the like.

As shown in FIG. 11, section (b), the coil body 7a thus formed is housed into the case 7b to manufacture the auxiliary magnet 7 including the jig insertion hole 27.

To the klystron structure 3, to which the engagement member 25 and the base 31 are attached as shown in FIG. 1, section (a), the main magnet 5 and the auxiliary magnet 7 having the jig insertion hole 27 formed therein as shown in FIG. 1, section (b) are mounted, and thus the klystron 1 of this embodiment is assembled.

Next, the adjustment of outputs taken from the output units 15 of the klystron 1 of this embodiment will be explained.

In order to adjust the high-frequency power outputs from the two output units 15 and 15 of the klystron 1, respectively, the output waveguides 13 and 13 connected to the respective output units 15 and 15 are deformed according to the required adjustment amount in each.

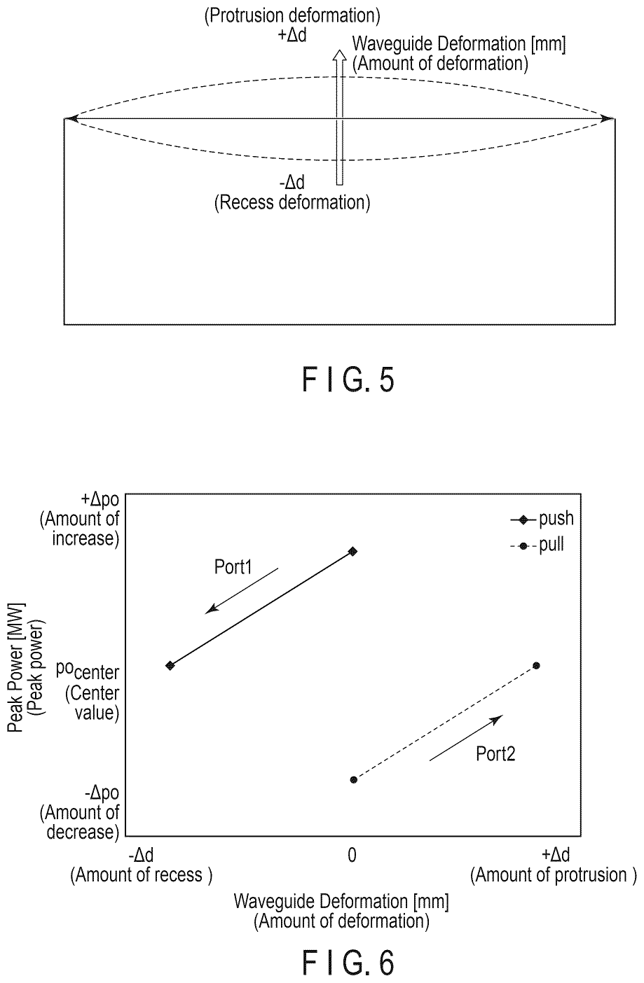

As shown in FIGS. 5 and 6, the long side surface 21 to which the engagement member 25 is fixed is pushed or pulled, and thus the shape of each of the output waveguides 13 and 13 is changed. For example, as shown in FIG. 6, by pushing the long side surface 21 of the output waveguide 13, the amount of depression (−Δd) is increased, and the peak power of the high-frequency power can be reduced.

When performing this pushing operation, a pushing jig 29b (see FIG. 12, section (b)) is used. As shown in FIGS. 2, section (c) and 4 as well, the male screw 41 formed in the main body of the pushing jig 29b is screwed into the female screw 51a formed in the face member 49 of the base 31, and the pushing jig 29b is advanced by screwing forward. Thus, the engagement member 25 is pushed against the face member 49 of the base 31, and the long side surface 21 of the output waveguide 13 is deformed into a recessed shape.

The pushing operation is performed by screwing the male screw 41 of the pushing jig 29b into the female screw 51a of the base 31, and therefore the long side surface 21 of the output waveguide 13 can be easily deformed into a recessed shape with a small amount of force.

On the other hand, as shown in FIG. 6, by pulling the long side surface 21 of the output waveguide 13, the protrusion (+Δd) is increased, and the high-frequency power output from each of the output unit 15 can be increased so as to increase the peak power of the high-frequency power.

When performing this pulling operation, a pulling jig 29a (see FIG. 12, section (a)) is used. As shown in FIGS. 2, section (b) and 3 as well, the distal end portion 37 of the pulling jig 29a is inserted into the screw hole 51 formed in the face member 49 of the base 31, and the male screw 37a of the distal end portion 37 is screwed into the female screw 25b of the engagement member 25, and the pulling jig 29b is advanced to screw forward. Thus, the engagement member 25 is pulled up while the end face 39 of the distal end portion 37 of the pulling jig 29a is in contact with the face member 49 of the base 31, and thus the long side surface 21 of the output waveguide 13 is deformed to protrude.

The pulling operation is simply screwing the male screw 37a at the distal end portion 37 of the pulling jig 29a into the female screw 25b on the engagement member 25, and then turning the pulling jig 29a while keeping the end face 39 on the distal end portion 37 side of the pulling jig 29a in contact with the face member 49 of the base 31. Thus, the long side surface 21 of the output waveguide 13 can be easily deformed by turning with a small amount of force.

The operation for pushing or pulling the long side surface 21 of each of the output waveguides 13 and 13 is performed by inserting the pulling jig 29a or pushing jig 29b into the jig insertion hole 27 of the auxiliary magnet 7. In this operation, it is not necessary to remove the auxiliary magnet 7 from the klystron 1, and therefore the output waveguide 13 can be easily and quickly deformed.

In particular, there is no need to remove the auxiliary magnet 7, reassemble the auxiliary magnet after adjustment, and then perform adjustment tests (confirmation) after resetting. Therefore, the lead time can be significantly reduced.

The jig insertion hole 27 formed in the auxiliary magnet 7 can be easily formed by winding a coil around the hole formation member 55 in place, and then removing the hole formation member 55, during the manufacture of the coil body 7a. Therefore, the jig insertion hole 27 can be easily formed in the auxiliary magnet 7.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A klystron comprising:
an electron gun;
a high-frequency interaction unit which amplifies high-frequency power input by interaction between an electron beam output from the electron gun and a high-frequency electric field;
a main magnet arranged in a ring-like shape around the high-frequency interaction unit;
an output waveguide connected to the high-frequency interaction unit;
an auxiliary magnet arranged in a ring-like shape at a position opposing the output waveguide;
an output unit which extracts the high-frequency power from the output waveguide; and
an output adjustment mechanism which adjusts output of the high-frequency power taken from the output unit by deforming the output waveguide,
wherein
the output adjustment mechanism comprises an engagement member fixed to the output waveguide, a jig insertion hole that penetrates from an outer side of the auxiliary magnet towards the engagement member, and a jig which is inserted from the outer side of the auxiliary magnet into the jig insertion hole and engages with the engagement member, and
the output waveguide is deformed by pushing or pulling the engagement member while engaging a distal end of the jig inserted from the outer side of the auxiliary magnet through the jig insertion hole with the engagement member.

2. The klystron of claim 1, wherein
the auxiliary magnet comprises a ring-shaped coil body formed by winding a coil in a circumferential direction, and the jig insertion hole includes a coil body transverse hole that crosses the coil body.

3. The klystron of claim 1, wherein
the output adjustment mechanism is provided in the output waveguide and comprises a base that forms a space between the engagement member and itself, the base includes a female screw unit in which a female screw is formed, and the jig comprises a pulling jig with a male screw formed on a distal end thereof, which screws into the engagement member, and a pushing jig that comprises a tip which is brought into contact with the engagement member as the pushing jig passes through the female screw unit.

4. The klystron of claim 3, wherein
the pulling jig has a main body that is larger in diameter than the distal end portion, and the distal end portion is inserted into the female screw unit of the base, and the male screw is screwed into the female screw unit of the engagement member, and the engagement member is pulled as the main body brings an end face of a distal end portion side thereof into contact with the base and rotates the end face.

5. The klystron of claim 3, wherein
the pushing jig comprises a male screw that engages with the female screw of the base, and the engagement member is pushed as the main body rotates the pushing jig while the male screw of the pushing jig are engaged with the female screw of the base.
